(19) United States
(12) Patent Application Publication
(10) Pub. No.: US 2003/0070663 A1
(43) Pub. Date: Apr. 17, 2003

(54) Method and system for powering an electronic circuit in a vehicle

(76) Inventor: Richard Pinsonneault, Grand-Mere (CA)

Correspondence Address: Mr. Marc Lupien, c/o GOUDREAU GAGE DUBUC, Stock Exchange Tower, Suite 3400, 800 Place Victoria, Montreal, QC, H4Z 1E9, CA

(21) Appl. No.: 10/269,042

(22) Filed: Oct. 11, 2002

(30) Foreign Application Priority Data
Oct. 11, 2001 (CA) 2,358,761

(51) Int. Cl. F02N 17/00

(52) U.S. Cl. 123/599; 123/179.5

(57) ABSTRACT

A method and system for powering an electronic circuit in a vehicle provided with an AC-CDI starting system is described herein. A power converter is connected to the magneto to tap some of the high voltage electricity produced thereby. The power converter converts this voltage to a voltage suitable to be used by an electronic circuit. Another aspect of the present invention consists in powering the interrogator circuit of a transponder system to prevent unwanted starting of the engine of the vehicle.

### FIELD OF THE INVENTION

The present invention relates to internal combustion engines. More specifically, the present invention is concerned with a system and a method to power an electronic circuit in a vehicle having an internal combustion engine.

### BACKGROUND OF THE INVENTION

Vehicles having an internal combustion engine usually require a battery which is used, amongst other, to supply electrical power to multiple electronic circuits. These circuits are used, for example, to control the startup of the engine. Once the engine is started, a generator mechanically powered by the engine supplies the required electricity to these circuits.

This use of a battery is a drawback since the power storage of batteries decreases with time, which implies the replacement of the battery and the potential lost of functionality of the vehicle.

Other types of lighter vehicles do not have a battery since it is too heavy. The circuit used to control the startup of the engine of these lighter vehicles are rather rudimentary and supplied directly via a high voltage provided by a magneto that is mechanically operated by the user. A drawback of these vehicles is that the circuits used are rudimentary.

### OBJECTS OF THE INVENTION

An object of the present invention is therefore to provide an improved method and system for powering an electronic circuit in a vehicle.

### SUMMARY OF THE INVENTION

More specifically, in accordance with an aspect of the present invention, there is provided a method for powering an electronic circuit in a vehicle comprising the acts of:

providing a power converter having an input and an output;

supplying electricity from a magneto of the vehicle to the input of the power converter before the internal combustion engine is started; and

connecting the output of the power converter to the electronic circuit.

According to another aspect of the present invention, there is provided a system for powering an electronic circuit in a vehicle comprises a power converter having an input connected to a magneto of the vehicle to be supplied with electricity therefrom before an engine of the vehicle is started, the power converter also includes an output connected to the electronic circuit to supply converted power thereto,

According to a third aspect of the present invention, there is provided a system for powering a starting controller of a vehicle, the system comprises a power converter having an input connected to a magneto of the vehicle to be supplied with electricity therefrom; the power converter also includes an output connected to the starting controller to supply converted power thereto; whereby the starting controller is energized before an engine of the vehicle is started.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1 is a simplified block diagram of an internal combustion engine including a system for powering an electronic circuit; and

FIG. 2 is a simplified block diagram similar to FIG. 1 where the internal combustion engine is mounted to a marine vehicle and where the circuit powered is a transponder system used as a key to prevent undesired startup of the engine.

### DESCRIPTION OF AN EMBODIMENT OF THE INVENTION

Generally stated, a first aspect of the present invention is concerned with the “tapping” of some of the electricity produced by the conventional magneto of a conventional internal combustion engine to power an electronic circuit.

A second aspect of the present invention is concerned with the use of such a technology where the engine is mounted to a marine vehicle and where the electronic circuit is a transponder system used as a key and mounted to the conventional safety device that must be present for the engine to start, such as for example a key that is attached to the driver to automatically stop the engine should the driver tall off the vehicle.

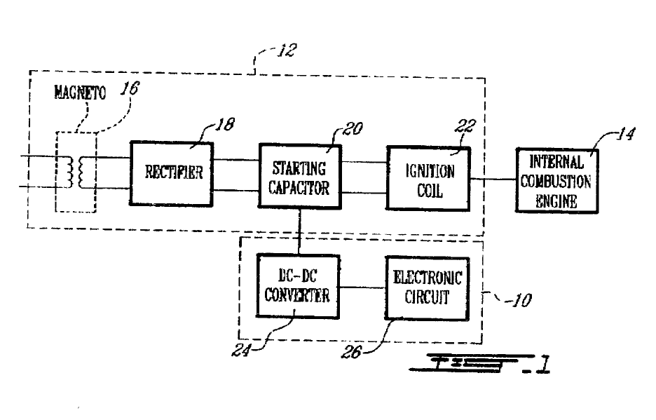

Turning now to FIG. 1 of the appended drawings, a system 10 according to an embodiment of the present invention will be described. The system 10 is connected to the starting assembly 12 of the vehicle, which is itself connected to the internal combustion engine 14.

As will be understood by one skilled in the art, an AC-CDI (Alternating Current—Capacitor Discharge ignition) starting assembly, such as the starting assembly 12, uses a conventional magneto 16 having a high-voltage output connected to a rectifier 18 to produce a positive sine-wave that is supplied to a starting capacitor 20 to charge it. When the capacitor 20 is fully charged, it is discharged into an ignition coil 22 to thereby start the internal combustion engine 14. Of course, since there is timing involved, there generally is a period during which the capacitor 20 is fully charged before it is discharged in the ignition coil 22. During this period, there is free electrical power generated by the magneto 16 and rectified by the rectifier 18. Indeed, the designers of such starting assemblies design them so that it is virtually sure that the capacitor 20 is fully charged before it is time for another ignition.

The system 10 of the present invention calls for a dc-dc converter 24 to be connected to the starting capacitor 20 to take a portion of the electricity supplied thereto by high-voltage output of the magneto 16 via the rectifier 18. The converter 24 takes this high voltage and transforms it into a low voltage adequate to supply an electronic circuit 26. Of course, the value of the low voltage depends on the type of electronic circuit 26 to be supplied.

As discussed hereinabove, the magneto 16 is generally oversized to ensure that the starting capacitor 20 is fully charged when it is needed. Therefore, the tapping of a relatively small portion of the energy generated by the magneto 16 to supply the dc-dc converter 24 does not significantly affect the operation of the starting assembly 12.

An advantage of the system 10 of the present invention is that the electronic; circuit 26 is powered before the internal combustion engine 14 is completely started without the use of a battery.

Of course, once the internal combustion engine 14 is started it may operate a generator (not shown) to power the electronic circuit 26.

One skilled in the art will understand that the electronic circuit 26 could be, for example, the starting controller circuit of the internal combustion engine 14.

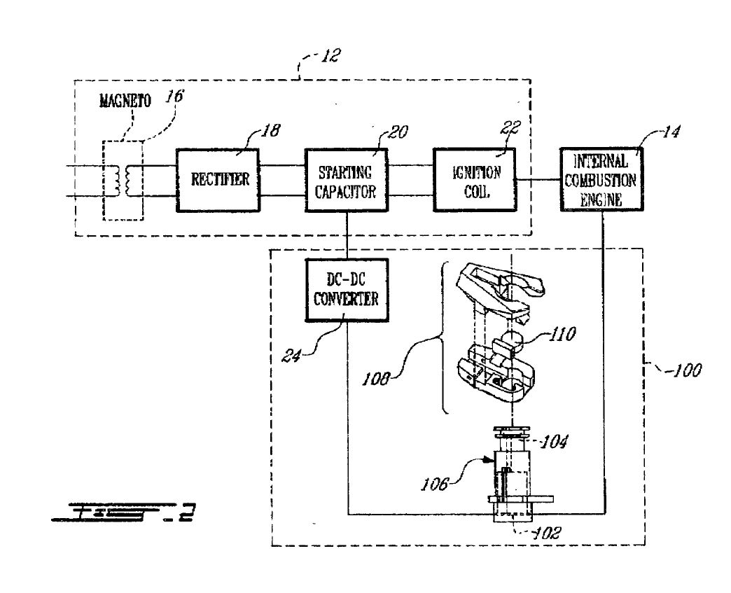

Turning now to FIG. 2 of the appended drawings, a system 100 similar to the system 10 of FIG. 1 will be described. The system 100 is designed to be mounted to a marine vehicle using an AC-CDI starting system and using a safety lanyard linking the driver and the vehicle to automatically stop the engine should the driver fall off the vehicle.

Again, this system 100 taps some of the electricity supplied to the starting capacitor of an AC-CDI starting system by a magneto and supplies it to a dc-dc converter 24.

The dc-dc converter 24 supplies a starting controller of the vehicle in the form of an interrogator circuit 102 of a transponder system. The interrogator circuit 102 includes a RF antenna 104 and both are mounted in a terminal 106 conventionally receiving a lanyard (not shown) mounted “key” 108 that must be mechanically connected to the terminal 105 for the engine 14 to operate. The key 108 is provided with a transponder circuit 110.

Generally stated, the interrogator circuit 102 transmits a question signal, using a predetermined Radio-Frequency signal, that is received by the transponder circuit 110. The question signal is then modified by the transponder circuit 110 according to a predetermined pattern to generate a response signal that is retransmitted to the interrogation circuit 102. Upon receipt of this response signal, the interrogator 102 compares the received response signal with an expected response signal. It the comparison is accepted, the interrogator circuit generates an output signal to the internal combustion engine 14 so that it may be started by the starting assembly 12.

It will easily be understood by one skilled in the art that the use of the power tapped from the magneto 16 enables the interrogator circuit 102 to determine if an adequate key 108 is mounted to the terminal 106, and start the engine 14 if it is the case, without the use of a battery.

It will also be easily be understood by one skilled in the art that other types of “electronic keys” could be powered by the power converter.

Of course, one skilled in the art will understand that a power converter other than a dc-dc converter could be used, as long as the electric power tapped from the starting capacitor is adequately regulated and/or filtered to supply the electronic circuit

It is also to be noted that should the electronic circuit supplied via the dc-dc converter be used to control the start-up of the engine a conventional rudimentary circuit (not shown) could be used to control the primary functions of the vehicle before the electronic circuit is supplied with sufficient electricity to work properly.

As will be apparent to one skilled in the art, the present invention allows the addition of complex electronic circuits to small vehicles while keeping the magneto as the only power source and without the need to modify the magneto by adding supplemental low voltage coils.

It is to be noted that it is believed within the reach of one skilled in the art to design or to select a power converter adequate to convert the signal from the starting capacitor to the electronic circuit.

Although the present invention has been described hereinabove bye the way of preferred embodiments thereof, it can be modified, without departing from the spirit and nature of the subject invention as defined in the appended claims.

What is claimed is:

1. A method for powering an electronic circuit in a vehicle comprising the acts of:
providing a power converter having an input and an output;
supplying electricity from a magneto of the vehicle to the input of the power converter before the internal combustion engine is started; and
connecting the output of the power converter to the electronic circuit.

2. The method of claim 1, wherein said power converter providing act includes providing a ac-dc power converter.

3. The method of claim 1, wherein said electricity supplying act includes connecting the input of the power converter to a starting capacitor of the vehicle.

4. A system for powering an electronic circuit in a vehicle comprises a power converter having an input connected to a magneto of the vehicle to be supplied with electricity therefrom before an engine of the vehicle is started the power converter also includes an output connected to the electronic circuit to supply converted power thereto.

5. The system recited in claim 4, wherein said power converted is a dc-dc converter.

6. The system recited in claim 4, wherein said input of said power converter is connected to the magneto of the vehicle via a starting capacitor of the vehicle.

7. The system recited in claim 4, wherein said electronic circuit includes an interrogating circuit controlling the operation of an engine of the vehicle to thereby prevent the starting of the engine in the absence of an electronic key associated with the interrogating circuit.

8. The system recited in claim 7, wherein the electronic key includes a transponder.

9. A system for powering a starting controller of a vehicle, the system comprises a power converter having an input connected to a magneto of the vehicle to be supplied with electricity therefrom; the power converter also includes an output connected to the starting controller to supply converted power thereto; whereby the starting controller is energized before an engine of the vehicle is started.

10. The system recited in claim 9, wherein said power converter is a dc-dc converter.

11. The system recited in claim 9, wherein said input of said power converter is connected to the magneto of the vehicle via a starting capacitor of the vehicle.

12. The system recited in claim 9, wherein said starting controller includes an interrogating circuit controlling the operation of an engine of the vehicle to thereby prevent the starting of the engine in the absence of an electronic key associated with the interrogating circuit.

13. The system recited in claim 12, wherein the electronic key includes a transponder.
